(19) United States
(12) Patent Application Publication
(10) Pub. No.: US 2004/0087314 A1
(43) Pub. Date: May 6, 2004

(54) Apparatus and method for tracking the location and position of an individual

(76) Inventor: Charles Duncan, Westford, MA (US)

Correspondence Address: LAHIVE & COCKFIELD, LLP., 28 STATE STREET, BOSTON, MA, 02109, US

(21) Appl. No.: 10/289,516

(22) Filed: Nov. 6, 2002

(51) Int. Cl. H04Q 7/20

(52) U.S. Cl. 455/456.1; 455/41.1

(57) ABSTRACT

An apparatus and method and provided for tracking the location and direction of an individual utilizing a direct radio frequency link between a mobile target and a mobile monitor. The apparatus and method utilize a mobile target device which may be affixed to an individual to be tracked utilizing a secure attachment mechanism. A mobile monitor device in bi-directional communication with the mobile target device is additionally provided. This radio frequency communication is encrypted in nature, thereby preventing unauthorized tracking of an individual by an non-intended third party. The mobile monitor device broadcasts the relative distance and direction between the mobile monitor device and mobile target device to a mobile monitor operator. A Bluetooth® enabled microprocessor may be utilized in transmitting and receiving this encrypted signal. Based upon data derived from the radio frequency information received by a mobile monitor, a relative distance and direction from a mobile monitor to a mobile target may be computed.

### TECHNICAL FIELD OF THE INVENTION

The present invention generally relates to electronic position and location tracking, and more particularly, to the tracking of an individual's position and location. The method utilizes remote target and monitor devices in electronic communication with each other to provide the requisite information.

### BACKGROUND OF THE INVENTION

Locating the position and direction of an individual regardless of his surroundings has long held promise as particularly desirable. Thwarting child abductions, for example, is greatly simplified if the location and direction of travel of a child is available at all times. Knowing this information, a parent may monitor his child without requiring the child to be in constant visual contact. Additionally, obtaining instantaneous information as to when a child has gone beyond their intended location, i.e., is lost or has been abducted, is essential in subsequently finding the child. The probability of locating the child diminishes greatly with the passing of time between the actual abduction, and the realization by a parent that the child is missing. Knowing a child's last location and his last direction of travel assists searchers as their initial search may be directed along probably pathways, as opposed to searches that start in a large geographic area without any preliminary guidance as to where the child may be headed.

Furthermore, position and direction information is not solely limited to monitoring children. For example, monitoring and tracking individuals proves beneficial when dealing with kidnapping targets such as political figures and corporate leaders, as well as the mentally ill or aged. Having position and direction information available in a real time format allows monitoring of these individuals before they are lost or abducted. Knowing when a tracked individual is approaching the confines of a “safe zone” aids in preventing the loss of a subject. Additionally, receiving an alert on a monitor device in the event that a tracking device is intentionally tampered with serves to limit the loss of a subject.

While this position and direction information is desirable, its implementation into a suitable product has proved difficult. Traditional tracking apparatus typically require an extensive external infrastructure to operate. Examples of this external infrastructure include ground based antenna arrays utilized in establishing communication between target and monitor, as well as satellite based technology such as the Global Positioning Satellite (GPS) network which aids in determining the position of a target. This external infrastructure limits the potential operating environments where tracking can occur. For instance, utilizing a position and direction tracking apparatus in a rural setting, in which the requisite ground based antenna arrays are not available, is impossible. A class field trip to a local farm, therefore, would not be able to utilize existing tracking means to guard against a lost child. Additionally, GPS based position and direction tracking is limited to only those areas in which a GPS signal can be received. In a large indoor space, or an outdoor locale covered by heavy tree cover, GPS signals may be interrupted, thereby rendering the tracking apparatus ineffective. A shopping mall or department store setting, for instance, would result in the loss of a GPS signal from a target, and the subsequent loss of position and direction data. Furthermore, traditional tracking technology employs a stationary monitoring station which processes data relating to the target's position. This monitoring station is typically remotely situated from the actual target. A parent who loses a child must first contact the remote monitoring location and will only then be given the position and direction information of their child. The requisite time delay could allow an abductor to move a child a significant distance before a parent can even obtain the last known position of the child. Such a large “head start” may make subsequent tracking and recovery difficult or impossible.

### SUMMARY OF THE INVENTION

The present invention addresses the above-described limitations associated with location and directional tracking of an individual. The present invention provides a direct communication link between a mobile target device attached to an individual to be tracked, and a mobile monitoring device. The mobile target device is capable of transmission and reception of a radio frequency signal. The mobile monitor device is also capable of receiving and transmitting a RF signal. This set of signals is utilized in calculating the distance between the monitor and target as well as the direction of the target device relative to the mobile monitor. The mobile monitor includes a broadcast element for delivering position and location information to a mobile monitor operator. This broadcast element may be a display element incorporated into the mobile monitor, or may be a voice prompt which audibly provides position and direction information to a user. Utilizing this broadcast element, the distance to, and the location of, an individual to be tracked may be monitored in real time. The mobile monitoring device may monitor a plurality of mobile target devices attached to different target objects. This capability allows a father, for example, to monitor the location and position of his two children simultaneously, using a single mobile monitor device. The converse is also possible; multiple mobile monitors may monitor one or more targets. Two parents, for example, may therefore monitor the position and location of their two children simultaneously, yet independently of each other. This real time monitoring addresses the inherent problems of a traditional remotely based monitor system, while concurrently offering the benefits gained by tracking of one or more targets simultaneously.

Normally, a mobile target device is affixed to an individual to be tracked. This device may take the form of a small wristwatch sized element, attached utilizing a secure band arrangement. The mobile target device contains a RF transceiver capable of communicating with a mobile monitor device utilizing an encrypted radio signal. The use of an encrypted radio signal prevents unauthorized monitoring of the data transmission between target and monitor. For example, the transceivers of the mobile monitor and mobile target can contain a Bluetooth® enabled microprocessor. These transceivers operate at a frequency of 2.4 GHz and incorporate existing Bluetooth® encryption technology. The communication between target and monitor, however, does not require the exclusive use of a Bluetooth® microprocessor, and may take any number of alternative forms.

The mobile monitoring device, which is in bi-directional communication with a mobile target device, requests that the mobile target device transmit a discrete data packet. This transmitted data packet identifies the transmitting mobile target device and provides the requisite data for target tracking. The mobile monitor receives this data packet via a plurality of antenna elements and then processes this signal for distance and direction information. After calculating a preliminary distance and location to an individual target, the rate at which subsequent data packets are requested may be modified. In a situation in which the mobile target is located far from the mobile monitor, the polling rate for packet request is increased such that the position of the mobile target is updated frequently. Frequent updates prevent the mobile target from straying beyond a safe zone in the interim between packet requests. Alternatively, where the mobile target is in close proximity to the mobile monitor, the variable polling rate for data packet request may be spaced further apart, as there is little likelihood the mobile target will stray beyond a safe zone in the interim between packet requests. This variable polling rate may be continuously varied based upon the distance between monitor and target. Additionally, the polling rate may be varied for numerous other conditions, including signal quality, as well as the rate at which distance between mobile monitor and mobile target is changing. The distance and direction information of each individual target relative to the monitor is then broadcast to a mobile monitor operator as a visual display on a graphical monitor, an audible prompt, or a combination of both.

The tracking apparatus may be expanded to include multiple targets and monitors and may include an automatic “hand off” procedure. This “hand off” procedure allows a mobile monitor to electronically pass the tracking and monitoring requirements to another mobile monitor. For example, if a parent is monitoring a single child (target) and intends to move beyond the predetermined safe zone, this mobile monitor electronically passes the monitoring requirements to a second mobile monitor operated by a second parent. In this scenario, this second mobile monitor is in communication with the target and may now monitor and track the target in the same manner the original monitor did. In light of the electronic “hand off,” this second parent is now presented with the distance and location information originally viewed by the first parent. The first parent is no longer responsible for the monitoring of the child, and may now move beyond the predetermined safe zone without setting an alert condition. A mobile monitor operator may also elect to manually “release” a mobile target from monitoring. A manual “release” allows a mobile monitor to temporarily cease any alarm conditions which would be triggered by a child wandering too far from the mobile monitor. This release can last for a fixed period of time, or may automatically be removed following a predetermined condition.

### BRIEF DESCRIPTION OF THE DRAWING

FIG. 1 illustrates a schematic diagram of the position and location indicating apparatus.

FIG. 2 illustrates a schematic representation of the mobile target device.

FIG. 3 illustrates a schematic representation of the mobile monitor device.

FIG. 4 illustrates an exemplary embodiment of a mobile target device band assembly.

FIG. 5 is a flow diagram which illustrates a method for tracking the location of an individual in accordance with the present invention.

### DETAILED DESCRIPTION

The direction and locating indicating apparatus for tracking a target object described herein can be employed in numerous locales. This apparatus may be used by a parent to monitor their child in an indoor shopping mall, for example, where multipath reflections of radio frequency signals are prevalent. The apparatus provides continuous distance and location information to an operator based upon radio frequency communication between the target and monitor. This information may be displayed graphically on a video display, or may be presented audibly to an operator.

A parent/guardian can also define a fixed “safe zone” for a target. The safe zone is an attribute of the mobile monitoring device. A mobile target device is first introduced to the mobile monitor by entering the mobile target device's identification number into the mobile monitor, At this point, a preliminary “safe zone” may be defined. This data entry can be accomplished utilizing a stylus and touch screen or a remote link to the mobile monitor, such as an Infrared (IR) signal, may be used. For example, a parent may elect a 30 foot “safe zone” for their child. Should a target venture outside this 30 foot safe zone, the mobile monitor user will be alerted. This alert can take the form of an audible warning or visual alert. In addition to the “safe zone” information, a parent may add additional identifying information, such as a child's name, which will be broadcast by the mobile monitor device. Identifying information and safe zone setting may be updated or changed at will by a mobile monitor operator.

Additionally, multiple mobile monitors may track multiple mobile targets. In a situation such as this, targets may be “handed off” among multiple authorized mobile monitor devices. The automatic hand off occurs when a mobile target device is within an area that is being monitored by multiple mobile monitor devices. As the mobile target device strays beyond the “safe zone” of an initial mobile monitor, this monitor sends a query to all other monitors who are authorized to watch the mobile target device. This query is used to determine if the mobile target device remains within the safe zone of the remaining authorized mobile monitor devices. If the mobile target device remains within the safe zone of a second authorized mobile monitor, monitoring of the target may be passed from a first monitor to a second monitor so long as the target is within the safe zone of the second monitor. The initial mobile monitor is now no longer responsible for monitor of the mobile target and does not receive an alert signal when the safe zone between monitor and target's exceeded. Following the hand off, the initial mobile monitoring device is alerted as to which remaining mobile monitoring devices are responsible for tracking the mobile target device.

In practice, a hand off procedure such as this allows a teacher to monitor the whereabouts of an entire class on a field trip. Should an individual student stray beyond the safe zone defined by his teacher, this student may be automatically “handed off” to an authorized chaperone so long as the student is within the safe zone defined by the chaperone. The teacher will be informed as to which chaperone is now responsible for this student and will no longer receive “safe zone” alerts regarding this handed off student.

The mobile monitor device also allows the “release” of a mobile target device. A release is a manual procedure by which an operator selects an individual mobile target device from a list of watched items and marks it as “released” The release condition prevents the initiation of an alert condition should the selected released mobile target stray beyond its respective safe zone, but does not prevent the continual tracking of a mobile target device. The release can be for a fixed period of time, such as 30 seconds or 1 minute, or can be permanent. The release can also be automatically removed upon the return of a mobile target within the confines of the predetermined safe zone.

A manual release proves useful in an amusement park setting. A father, for example, may elect to temporarily release his daughter after placing her on a roller coaster. Absent a release function, when riding this roller coaster, the daughter may initiate numerous alert conditions for straying beyond the safe zone set by her father. While the roller coaster is in motion, however, there is little potential for an abduction to occur. Using a manual release, this father may temporarily halt alerts while his daughter continues to enjoy the ride. After the ride is complete and the child is back within a safe zone of the mobile monitor, the release condition may be manually or automatically removed. Monitoring then resumes in a pre-released fashion.

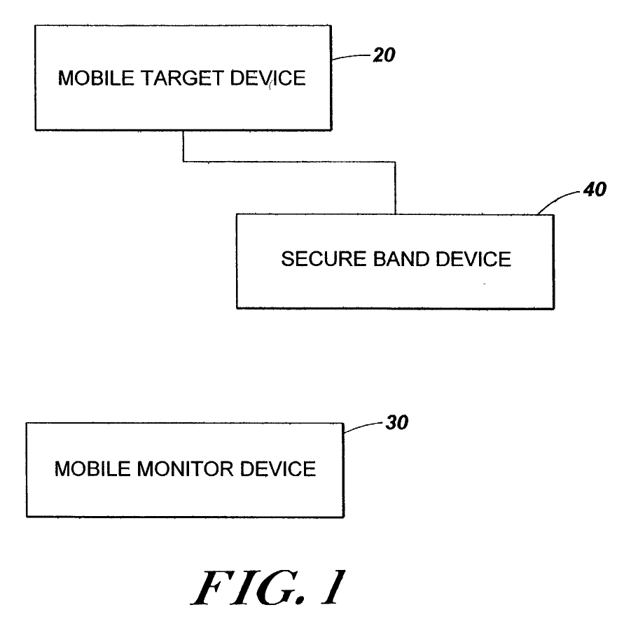

Referring now in detail to the drawing wherein like parts are designated by like reference numerals throughout, FIGS. 1-5 illustrate examples of a position and direction indicating apparatus for locating an individual. Although the present invention will be described with reference to the example embodiments illustrated in the figures, it should be understood that the present invention may be embodied in many alternative forms. In addition, any suitable size, shape, or type of elements or materials could be utilized.

FIG. 1 illustrates one example of a position and direction indicating apparatus for locating an individual. This position and direction indicating apparatus includes a mobile target device 20 sized and constructed for attachment to an individual to be tracked. Resistance to shock and the elements is included in the mobile target device 20 design so it can be used outdoors. The mobile target device 20 can be sized to fit a small child in an unobtrusive manner. Attachment of the mobile target device 20 can be accomplished utilizing a secure band device 40. This secure band device 40 is affixed to the mobile target device 20 such that attachment and removal of the mobile target device 20 from the individual may be accomplished only by an authorized user. This secure band arrangement can look similar to a typical wristwatch band. Unlike an ordinary wristwatch, however, the secure band device 40 may incorporate a locking mechanism allowing only those authorized to install and remove the band. Mobile monitor device 30 initiates communication with a mobile target device 20 by sending a data request. In response to this request, the mobile target device 20 transmits a short data packet. This data packet serves to identify the transmitting mobile target device 20 and is utilized in determining distance and location of the mobile target device 20 relative to the mobile monitor device 30. This distance and direction information may be displayed to a user of the mobile monitor device 30 on an integral graphical display element, or may be audibly delivered to a user.

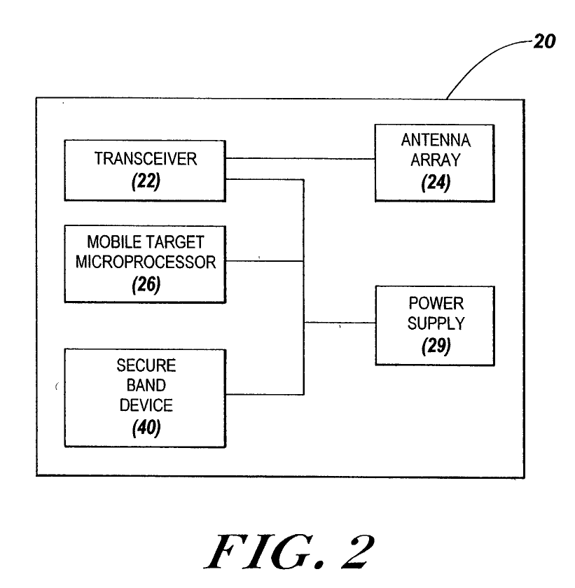

FIG. 2 schematically represents the mobile target device 20 noted above. This mobile target device 20 is capable of transmitting and receiving a radio frequency signal. Power for the transmission of this signal may be provided by an on-board power supply 29. For example, this power supply may take the form of an internal rechargeable battery. Recharging of this battery can occur utilizing an inductive coupling.

The transceiver 22 transmits and receives RF signals through the antenna array 24. The antenna array 24 may take the form of either a single antenna capable of transmitting and receiving a signal simultaneously, or may include a plurality of antenna elements providing transmitting and receiving capabilities. The mobile target device additionally includes a microprocessor element 26 which may transmit a Bluetooth® radio frequency signal. This microprocessor element 26 provides for the transmitting of a data packet by the mobile target device 20 upon reception of a data request transmitted from a mobile monitor device 30 [not shown]. Utilizing a Bluetooth® enabled microprocessor, accurate timing information may be transmitted within the response data packet such that this timing information may subsequently be utilized in position and direction processing. Additionally, the use of a Bluetooth® enabled microprocessor allows for the encryption of the transmitted signal utilizing a Bluetooth® encryption algorithm. Monitoring by a non-intended party may be prevented, thus providing greater security since only those who possess the appropriate decryption means may track the individual. Furthermore, the microprocessor element 26 of the mobile target device is in electrical communication with the secure band assembly 40. The secure band assembly contains several electrically conducting wires impregnated within the band assembly which are arranged such that any attempts to forcibly remove the secure band will break the electrical pathway of these wires. The microprocessor will detect this forcible removal and will alert the mobile monitoring device in communication with this mobile target device. This alert serves to give a mobile monitoring device operator advance notice of an impending attempt to forcibly remove a mobile target device.

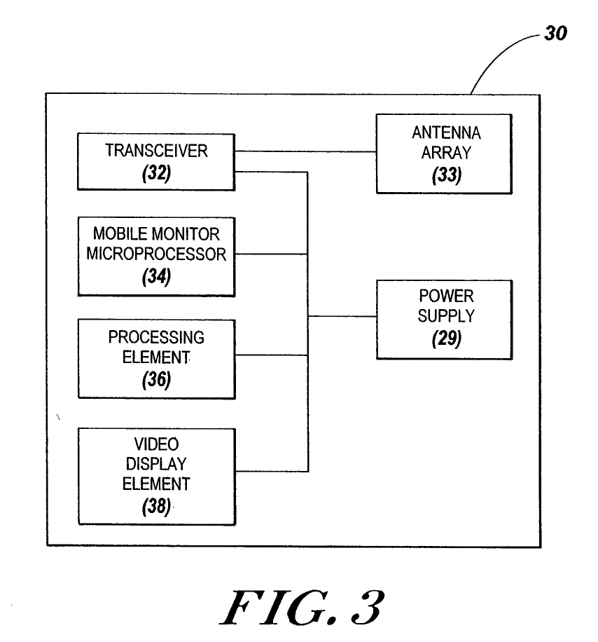

FIG. 3 discloses a schematic of a mobile monitor device 30 for use with the mobile target device described previously. The mobile monitor device contains a transceiver element 32 capable of transmitting and receiving a radio frequency signal via the monitor antenna array 33. Antenna array 33 may include a single antenna element capable of receiving and transmitting simultaneously, or may comprise multiple antenna elements. Suitable types of antenna elements include both omni-directional antenna elements as well as broad cardioid elements. A monitor microprocessor 34 is in electrical communication with the mobile transceiver element 32. The monitor microprocessor may be a Bluetooth® enabled microprocessor capable of un-encrypting and processing a Bluetooth® encrypted transmission. This un-encrypted signal is introduced to a mobile monitor processing element 36 which evaluates the signal information derived from the communication between mobile monitor and mobile target and processes said information to determine relative position and location of a mobile target device 20 relative to the mobile monitor device 30. The mobile monitor microprocessor 34 and the processing element 36 may be combined within a single microprocessor, thereby reducing system complexity and cost. The position and direction information is further forwarded to a mobile monitor video display element 38 which is electrically coupled to the processing element 36 of the mobile monitor. The video display 38 element graphically displays the location of the mobile target 20 relative to the location of the mobile monitor 30. Additionally, a “cookie trail” may be included on this display such that the prior positions of the mobile target are graphically represented as a string of characters leading to the current position. This information serves to provide direction of travel information of the mobile target based upon the interpolation of prior positions. Position and location information may also be broadcast to a user audibly. This audible information may either replace the video display 38, or may be used in conjunction with the video display 38. Furthermore, the processing element 36 allows a mobile monitor operator to define a fixed “safe zone” which comprises an area radiating from the mobile monitor at a fixed distance. A safe zone for each monitored mobile target device is set by a mobile monitor operator by first identifying the correct mobile target device and then defining an allowable distance using a stylus and touch sensitive screen. This touch sensitive screen is incorporated within the video display 38, thereby reducing system complexity. The location of a target within this zone may be monitored by the monitor microprocessor 34 and upon exceeding the scope of the set boundary, an alert message is delivered to the operator of the mobile monitor. This alert can be audible or displayed on the video display 38. Defining a safe zone such as this allows an operator to monitor the location of a target without requiring constant monitoring of the mobile monitor video display 38. The mobile monitor device also includes an internal power supply 39 to provide energy to the components of the mobile monitor 30. This power supply may take the form of a rechargeable or replaceable battery array, which thereby allows the mobile monitor to operate remotely. Additionally, the mobile monitoring device may contain provisions for connection of an external power supply element, thereby allowing the unit to operate without reliance on the internal batteries, and simultaneously allowing the recharging of the on board batteries.

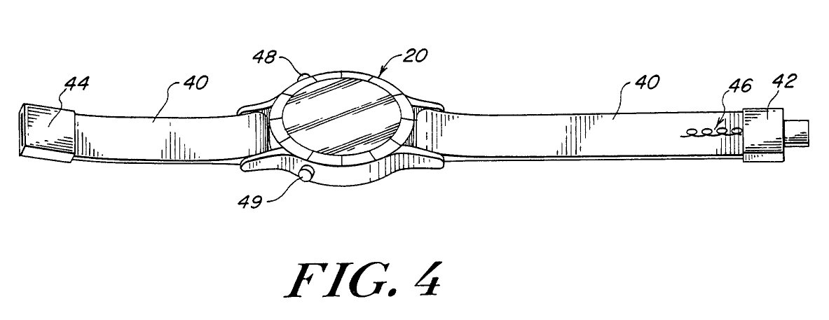

FIG. 4 illustrates a secure band 40 arrangement for use with the present invention. The secure band resembles a traditional watch band, and is manufactured of a suitable material, such as leather, hinged metallic links, or a hypoallergenic plastic. Various other suitable materials also may be used. This secure band includes a two piece locking mechanism comprising a male locking element 42 and a female locking element 44. The male locking element 42 and female locking element 44 are designed to couple together to provide a secure locking mechanism that can only be released by an authorized person. The locking mechanism may be mechanical in nature, utilizing a traditional key to unlock the band or an electromagnetic lock may be substituted. An electromagnetic lock requires an electric or magnetic signal for unlocking. A magnetic key may be used, or an electrical signal may be sent to the lock from the mobile target device 20 after receiving the appropriate unlocking code from the mobile monitor device 30. The position of the locking mechanism is easily adjustable utilizing a plurality of adjustment holes 46 or a ratcheting mechanism, thereby allowing the installation of the secure band 40 on multiple users with a variety of wrist sizes. The secure band assembly also included a plurality of buttons (48, 49), located around the perimeter of the mobile target device. When activated in the appropriate combination, for an appropriate period of time, a mobile target can manually trigger an alert condition which will be received by a mobile monitor in communication with this target. The timing requirements and button locations are such that accidental triggering of an alert condition by a mobile target is avoided.

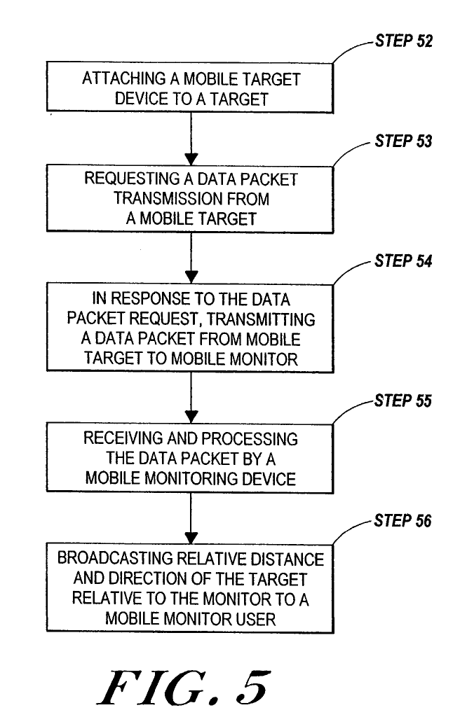

FIG. 5 is a flow diagram for practicing the pending invention. A mobile target device must first be attached to the target to be monitored (step 52). The attachment of the mobile target 20 to the individual to be monitored may occur utilizing a secure band arrangement 40, or may utilize another suitable means such as a clip or an adhesive backing. The mobile monitor device 30 transmits a data packet request to a mobile target device 20 via a radio frequency link (step 53) and the mobile target device 20 transmits a short data packet in response to the request (step 54). This data packet includes data capable of identifying the transmitting mobile target device 20 as well as data necessary for distance and location tracking. The mobile monitor device 30 receives and processes the data packet to determine distance and location of a mobile target 20 relative to the mobile monitor 30 (step 55). Finally, this position and location data is broadcast to a mobile monitor 30 operator (step 56). Position and location data may be graphically displayed on a video display 38 incorporated with a mobile monitor 30, or may be audibly delivered to a mobile monitor operator as plain text spoken commands. Steps 53-56 are then repeated at various polling rates to pinpoint the location and direction of the individual being tracked.

Numerous modifications and alternative embodiments of the invention will be apparent to those skilled in the art in view of the foregoing description. Accordingly, this description illustrative only and is for the purpose of teaching those skilled in the art the best mode for carrying out the invention. Details of the structure may vary substantially without departing from the spirit of the invention, and exclusive use of all modifications that come within the scope of the appended claims is reserved. It is intended that the invention be limited only to the extent required by the appended claims and the applicable rules of law.

Having described the invention, what is claimed as new and protected by Letters Patent is:

What is claimed is:

1. A position and location indicating apparatus for locating an individual comprising:
a mobile target device sized for attachment to said individual to be tracked, said target device having circuits for transmitting and receiving radio frequency signals,
a mobile monitor device, said monitor including a circuit capable of providing bi-directional communication with a mobile target device,
a processing element associated with said monitor device, said processing element being capable of calculating relative distance and direction from said mobile monitoring device to said mobile target device based upon information derived from the communication between the mobile target device and the mobile monitoring device, and
a broadcast element associated with said monitor device, said broadcast element capable of providing relative distance and direction information between a mobile monitor and a mobile target to a mobile monitor operator.

2. The apparatus of claim 1, wherein said processing element comprises a digital signal processing circuit for differentiating a transmitted signal from said mobile target device from extraneous multipath signals in the operating environment regardless of relative signal strength.

3. The apparatus of claim 1, wherein said mobile target and mobile monitor device comprises a radio frequency transceiver and microprocessor capable of transmitting and receiving a Bluetooth® encrypted radio frequency signal.

4. The apparatus of claim 1, wherein said mobile monitoring device comprises circuitry to poll said mobile target device to send a data packet at a variable polling rate.

5. The apparatus of claim 1, wherein said mobile monitoring device comprise both distance and direction measuring means on a single microchip.

6. The apparatus of claim 1, said mobile monitoring device comprises a plurality of antenna elements utilized in receiving and transmitting a radio frequency signal.

7. The apparatus of claim 6, wherein said plurality of antenna elements comprise a pattern selected from the group consisting of omni-directional and broad cardioid patterns.

8. The apparatus of claim 1, wherein said mobile target element comprises a secure band to affix said element to an individual to be tracked.

9. The apparatus of claim 1, wherein said processing element is capable of calculating the distance and direction of said mobile target device relative to said mobile monitor device in a continuous manner.

10. The apparatus of claim 1, wherein said broadcast element comprises a graphical display incorporated within the mobile monitor.

11. The apparatus of claim 1, wherein said broadcast element comprises an audio transmitter incorporated within the mobile monitor

12. The apparatus of claim 10, wherein said graphical display is capable of continuously displaying the relative position of said mobile target device to said mobile monitoring device in real time.

13. The apparatus of claim 10, wherein said graphical display includes a touch sensitive overlay for use in conjunction with a user manipulated stylus.

14. The apparatus of claim 11, wherein said audio transmitter is capable of continuously providing relative position of said mobile target device to said mobile monitor device in real time using spoken distance and direction instructions.

15. The apparatus of claim 1, wherein a safe zone for a mobile target device may be defined by an operator of said mobile monitor device.

16. The apparatus of claim 15, wherein said safe zone radially extends at a predefined distance to said mobile monitor device.

17. The apparatus of claim 15, wherein said mobile monitor device initiates an alert condition which is transmitted to a user by way of the broadcast element when a mobile target device strays beyond the predefined safe zone.

18. The apparatus of claim 1, wherein said mobile monitor device comprises hand off circuitry for automatically passing the tracking responsibility of mobile target devices to other authorized mobile monitor devices in communication with said mobile target device.

19. A secure band assembly for use with a mobile target device comprising:
an adjustable strap assembly, and
a remotely activated locking mechanism, said locking mechanism being capable of unlocking only upon receiving an appropriate encrypted unlocking signal.

20. The secure band assembly of claim 19, wherein said band assembly is water resistant.

21. The secure band assembly of claim 19, wherein said band assembly is manufactured of a hypoallergenic material

22. The secure band assembly of claim 19, wherein said band assembly is designed to fit the wrist or ankle of a child.

23. The secure band assembly of claim 19, wherein said band assembly comprises a tamper detection means embedded within the band.

24. The secure band assembly of claim 19, wherein said band assembly comprises a means for initiating the transmission of an alert condition to the mobile monitor device.

25. A method for tracking the location an individual, comprising the steps of:
providing a mobile target device on the individual to be tracked,
providing a mobile monitor device capable of communication with said mobile target device,
requesting the transmission of a data packet from said mobile target device by said mobile monitor,
transmitting a data packet from said mobile target via a radio frequency link between said mobile target device and said mobile monitor device,
receiving and processing said data packet by said mobile monitor device such that distance and direction from said mobile monitor device to said mobile target device can be computed based upon information derived from the communication between said mobile target device and said mobile monitor device, and broadcasting the relative distance from said mobile monitor device to said mobile target device to a mobile monitor device operator.

26. The method of claim 25, comprising the step of attaching said mobile target device to an individual to be monitored utilizing a tamper resistant band arrangement.

27. The method of claim 25, comprising the steps of establishing a communication link between said mobile target device and said mobile monitor device utilizing an encrypted Bluetooth® signaling protocol.

28. The method of claim 25, comprising the steps of polling said mobile target device by said mobile monitor device at a variable rate.

29. The method of claim 25, comprising the steps of receiving a transmitted signal from said mobile target device utilizing a plurality of antenna elements in electrical communication with said mobile monitor device.
